(19) United States
(12) Patent Application Publication
(10) Pub. No.: US 2007/0067822 A1
(43) Pub. Date: Mar. 22, 2007

(54) Multi-authenticating method and system also for use in organism authenication

(75) Inventor: Seiichi Itoda, Saitama (JP)

Correspondence Address: VENABLE LLP, P.O. BOX 34385, WASHINGTON, DC, 20043-9998, US

(73) Assignee: OKI ELECTRIC INDUSTRY CO., LTD., TOKYO (JP)

(21) Appl. No.: 10/565,884

(22) PCT Filed: Jun. 15, 2004
(86) PCT No.: PCT/JP04/08682

§ 371 Date: Jan. 25, 2006

(30) Foreign Application Priority Data
Jul. 25, 2003 (JP) JP2003-279637

(51) Int. Cl. H04L 9/32

(52) U.S. Cl. 726/2

(57) ABSTRACT

Advantages of both of organism authentication and ordinary authentication are taken out.

A multi-authenticating system also for use in organism authentication has at least a first authenticating apparatus A 12 and a second authenticating apparatus B 13 and also has a managing apparatus 11 which manages them. The first authenticating apparatus A 12 includes a biometrics authenticating apparatus 12-1 which makes the organism authentication by using a physical feature of the apparatus user as an authentication target and a card issuing apparatus 12-2 which issues a card as an authenticating medium when a result of the organism authentication is affirmative. The second authenticating apparatus B 13 includes a card reader 13-1 which reads the card in order to authenticate the user by using the card and a control apparatus 13-2 which permits use of the apparatus in accordance with a result of the authentication by the card. Those apparatuses are selectively used in accordance with characteristics of the authentication of each system. The card can be also collected by a card collecting apparatus 14-1 provided in an authenticating apparatus C 14.

### TECHNICAL FIELD

The invention relates to authenticating method and system in which personal authentication by a personal property such as IC card, magnetic card, or the like or authentication by a password and biometrics authentication are combined.

### BACKGROUND ART

There are the following systems as conventional personal authenticating systems.

(1) One is a personal authenticating system by a personal property. It is a system in which an individual owns an IC card or a magnetic card and a personal ID or information is preliminarily stored in the card, thereby making personal authentication.

(2) The other is a personal authenticating system using biometrics. It is an authenticating system using a personal physical feature such as fingerprint, iris, or the like.

In FIG. 23, characteristics of the above authenticating systems are shown in comparison. As shown in the diagram, the “personal authentication by a personal property” and the “biometrics personal authentication” show the symmetrical characteristics.

That is, the “personal authentication by a personal property” has advantages in which the person can be recognized at low costs, an authenticating time is short, and an authenticating speed is high. On the contrary, it has disadvantages in which there is a risk that the system is abused and, when he does not carry his personal property, he cannot be authenticated, and the like.

On the other hand, the “biometrics authentication” has advantages in which a risk that the system is abused is low and the person can be certainly authenticated because the authentication is made by a personal physical feature. On the contrary, it has disadvantages in which an authenticating apparatus is expensive and it takes a relatively long authenticating time.

### DISCLOSURE OF INVENTION

To solve the above problems, according to the invention, there is constructed a system which can compensate the advantages and disadvantages by combining the “personal authentication by a personal property” and the “biometrics personal authentication”.

That is, the following constructions are used.

According to the present invention, there is provided a multi-authenticating method also for use in organism authentication, comprising the steps of:

making the organism authentication by using a physical feature of an authentication target and, when a result of the organism authentication indicates an affirmative, thereafter issuing an authenticating medium by which simple and prompt authentication can be made on the assumption that the affirmative result of the organism authentication is obtained; and

authenticating the authentication target by using the authenticating medium and permitting use of an apparatus in accordance with a result of the authentication by the authenticating medium.

Moreover, in the multi-authenticating method also for use in the organism authentication, the authenticating medium may be a personal property of the user of the apparatus as an authentication target.

Moreover, in the multi-authenticating method also for use in the organism authentication, the authenticating medium may be a password.

Moreover, the multi-authenticating method also for use in the organism authentication may further comprise a step of collecting the personal property as the authenticating medium.

Moreover, in the multi-authenticating method also for use in the organism authentication, the organism authentication may be accompanied in the step of collecting the personal property as the authenticating medium.

Further, according to the present invention, there is also provided a multi-authenticating system also for use in organism authentication, comprising:

a first authenticating apparatus constructed by an organism authenticating unit which makes the organism authentication by using a physical feature of an authentication target and a medium issuing unit which issues an authenticating medium when a result of the organism authentication indicates an affirmative; and

a second authenticating apparatus constructed by a medium authenticating unit which authenticates the authentication target by using the authenticating medium and an apparatus control unit which permits use of an apparatus in accordance with a result of the authentication by the authenticating medium.

Moreover, in the multi-authenticating system also for use in organism authentication, the authenticating medium may be a personal property of the user of the apparatus as an authentication target.

Moreover, in the multi-authenticating system also for use in the organism authentication, the authenticating medium may be a password.

Moreover, the multi-authenticating system also for use in the organism authentication may further comprise a collecting unit which collects the personal property as the authenticating medium.

Moreover, the multi-authenticating system also for use in the organism authentication, the first authenticating apparatus may write all data necessary for the subsequent authentication into the personal property of the user of the apparatus, and the second authenticating apparatus can solely discriminate whether or not the use of the apparatus is permitted on the basis of the data obtained from the personal property.

Moreover, in the multi-authenticating system also for use in the organism authentication, the organism authenticating unit which makes the organism authentication at the time of the collection of the personal property may be provided in a recognizing apparatus having the collecting unit which collects the personal property as the authenticating medium.

### BRIEF DESCRIPTION OF DRAWINGS

FIG. 1 is a block diagram showing a system construction of an embodiment 1 of the invention.

FIG. 2 is a block diagram showing a functional construction of a managing apparatus in FIG. 1.

FIG. 3 is a block diagram showing a functional construction of an authenticating apparatus A in FIG. 1.

FIG. 4 is a block diagram showing a functional construction of an authenticating apparatus B in FIG. 1.

FIG. 5 is a block diagram showing a functional construction of an authenticating apparatus C in FIG. 1.

FIG. 6 is a diagram showing an example of authentication data.

FIG. 7 is a diagram showing an example of a registrant DB.

FIG. 8 is a diagram showing an example of card input data.

FIG. 9 is a diagram showing an example of apparatus data.

FIG. 10 is a diagram showing an example of biometrics data.

FIG. 11 is a flowchart showing the authenticating operation in the authenticating apparatus A.

FIG. 12 is a flowchart showing the authenticating operation in the authenticating apparatus B.

FIG. 13 is a flowchart showing the authenticating operation in the authenticating apparatus C.

FIG. 14 is a block diagram showing a system construction of an embodiment 2 of the invention.

FIG. 15 is a block diagram showing a functional construction of an authenticating apparatus B in FIG. 14.

FIG. 16 is a block diagram showing a functional construction of an authenticating apparatus C in FIG. 14.

FIG. 17 is a diagram showing an example of card input data in the embodiment 2.

FIG. 18 is a flowchart showing the authenticating operation in an authenticating apparatus B in the embodiment 2.

FIG. 19 is a flowchart showing the authenticating operation in an authenticating apparatus C in the embodiment 2.

FIG. 20 is a block diagram showing a system construction of an embodiment 3 of the invention.

FIG. 21 is a block diagram showing a functional construction of an authenticating apparatus C in FIG. 20.

FIG. 22 is a flowchart showing the authenticating operation in an authenticating apparatus C in the embodiment 3.

FIG. 23 is an explanatory diagram of comparison contents of “authentication by a personal property” and “biometrics authentication”.

### BEST MODE FOR CARRYING OUT THE INVENTION

Best modes of the invention will be described hereinbelow by using embodiments.

[Embodiment 1]

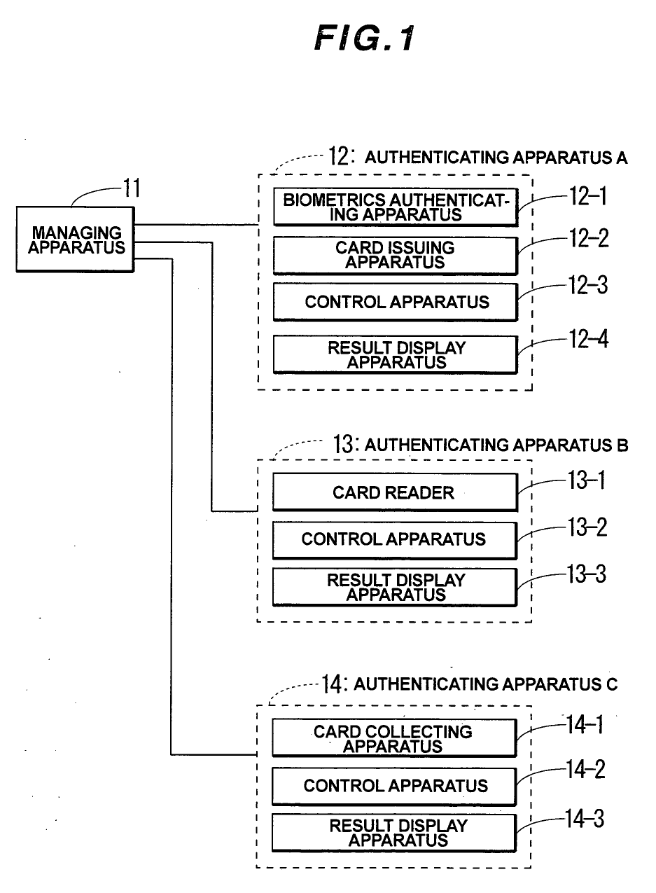

FIG. 1 is a system constructional diagram of an embodiment 1 of the invention. In FIG. 1, a managing apparatus 11 manages the whole system and makes authentication in which authentication by a personal property or a password and biometrics authentication are combined. The managing apparatus 11 is connected to an authenticating apparatus A 12, an authenticating apparatus B 13, and an authenticating apparatus C 14 by a network.

The authenticating apparatus A 12 has a biometrics authenticating apparatus 12-1, a card issuing apparatus 12-2, a control apparatus 12-3, and a result display apparatus 12-4.

As an example of the control apparatus 12-3, an electric lock or a charging apparatus can be mentioned. Although the control apparatus 12-3 is provided together with the card issuing apparatus 12-2 in the example shown in the diagram, it is also possible to use a construction without the control apparatus.

The result display apparatus 12-4 is an apparatus for notifying the user of a result by using an LED or an LCD.

The user makes biometrics authentication by using the authenticating apparatus A 12 and receives a card. In this instance, in the construction as shown in the diagram, unlocking of a door or payment of money can be performed at the same time.

The authenticating apparatus B 13 has a card reader 13-1, a control apparatus 13-2, and a result display apparatus 13-3.

As an example of the control apparatus 13-2, an electric lock or a charging apparatus can be mentioned.

In the authenticating apparatus B 13, the user can perform the unlocking of the door or the payment by using the card.

The authenticating apparatus C 14 has a card collecting apparatus 14-1, a control apparatus 14-2, and a result display apparatus 14-3.

The card collecting apparatus 14-1 may have the function of the card reader.

As an example of the control apparatus 14-2, an electric lock or a charging apparatus can be mentioned. Although the control apparatus 14-2 is provided in the example shown in the diagram, it is also possible to use a construction without the control apparatus.

The user returns the card by the card collecting apparatus 14-1. In this instance, according to the system with the construction shown in the diagram, the unlocking of the door or the payment of money can be performed at the same time.

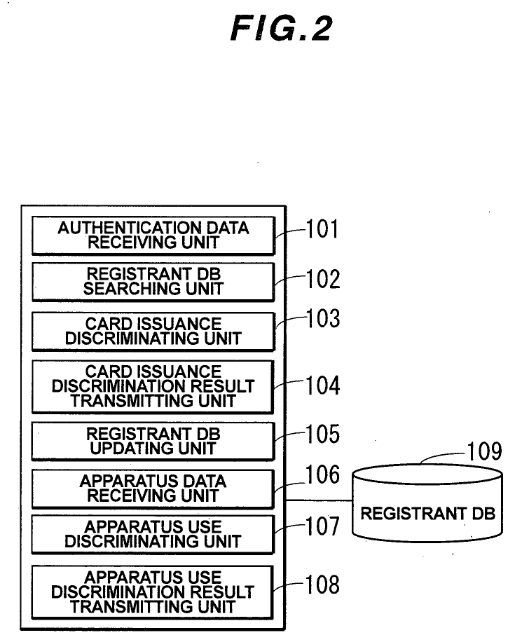

FIGS. 2 to 5 are functional block diagrams of the apparatuses in FIG. 1.

FIG. 2 is the functional block diagram of the managing apparatus 11. In FIG. 2, an authentication data receiving unit 101 receives authentication data from the authenticating apparatus A 12.

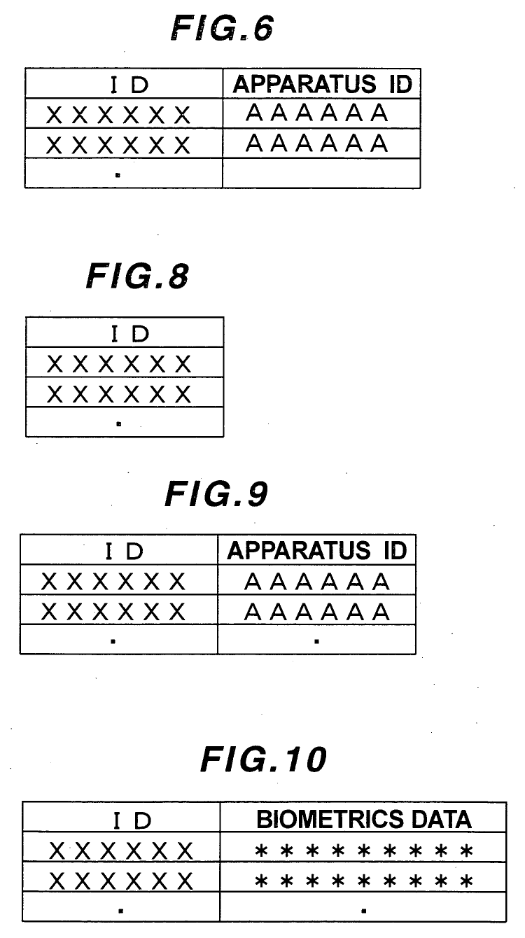

FIG. 6 shows an example of the authentication data. The authentication data is constructed by information such as “ID” as a unique number linked with an ID of a registrant DB 109, “apparatus ID” to identify the authenticating apparatus A 12, and the like.

Returning to FIG. 2, a registrant DB searching unit 102 searches for data from the registrant DB 109 by using the ID as a key.

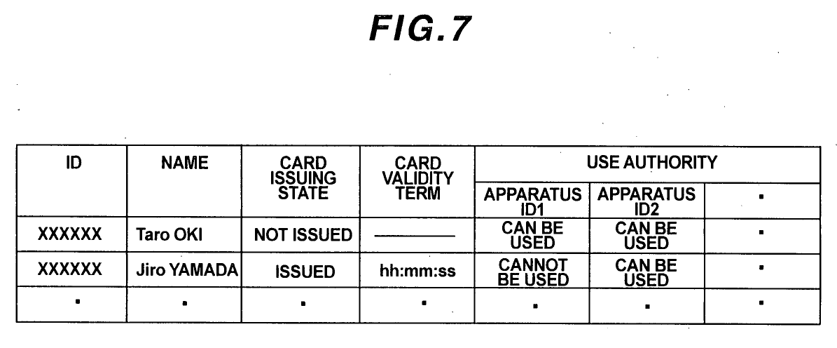

FIG. 7 shows an example of the registrant DB 109. The registrant DB 109 is constructed by information such as “ID” as a unique number, “name”, “card issuing state” to discriminate whether or not the card has already been issued, “card validity term” showing the terms of validity in which the card can be used, “use authority” showing the apparatus having the use authority, and the like.

Returning to FIG. 2, a card issuance discriminating unit 103 discriminates whether or not the card is issued on the basis of the “card issuing state”, “use authority”, and the like of the registrant DB 109 searched for by the ID of the authentication data. As an example of discriminating the card issuance, a method whereby it is determined that the card can be issued in the case where the “card issuing state” indicates that the card is not issued yet and the use authority of the authenticating apparatus A 12 indicates “can be used” can be mentioned.

A card issuance discrimination result transmitting unit 104 transmits a result of the discrimination about the card issuance and card input data to the authenticating apparatus A 12.

FIG. 8 shows an example of the card input data. The card input data is constructed by information such as “ID” as a unique number linked with the ID of the registrant DB 109, and the like.

Returning to FIG. 2, a registrant DB updating unit 105 updates the “card issuing state”, “card validity term”, and the like of the registrant DB 109.

An apparatus data receiving unit 106 receives apparatus data from the authenticating apparatus B 13 or the authenticating apparatus C 14.

FIG. 9 shows the apparatus data. The apparatus data is constructed by information such as “ID” as a unique number linked with the ID of the registrant DB 109, “apparatus ID” uniquely allocated to each apparatus in order to identify the apparatus, and the like.

Returning to FIG. 2, an apparatus use discriminating unit 107 discriminates whether or not use of the apparatus is permitted on the basis of the “card validity term”, “use authority”, and the like of the registrant DB 109 searched for by the ID of the apparatus data. As an example of discriminating the use of the apparatus, a case where the card is within the card validity term and the use authority indicates “can be used” can be mentioned.

An apparatus use discrimination result transmitting unit 108 transmits a discrimination result of the apparatus use discriminating unit 107 to the authenticating apparatus B 13 or the authenticating apparatus C 14.

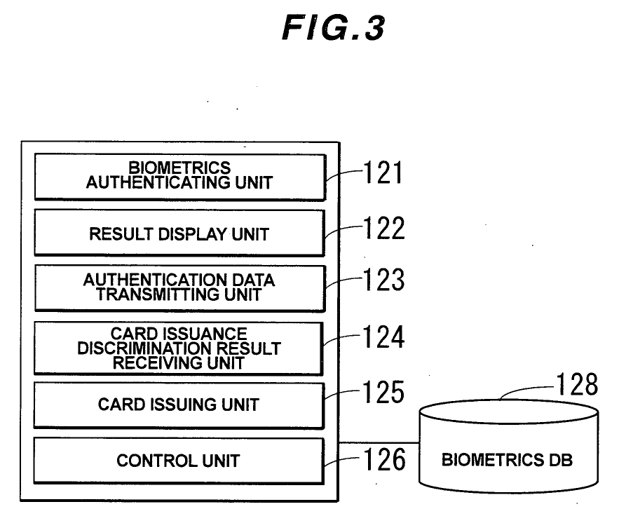

FIG. 3 is the functional block diagram of the authenticating apparatus A 12. In FIG. 3, a biometrics authenticating unit 121 obtains biometrics data of the user by using the biometrics authenticating apparatus 12-1 in FIG. 1. The user is authenticated by discriminating whether or not the obtained biometrics data coincides with biometrics data which has previously been registered in a biometrics DB 128.

FIG. 10 shows an example of the biometrics DB 128. The biometrics DB is constructed by information such as “ID” as a unique number linked with the ID of the registrant DB 109, “biometrics data” as data to authenticate the individual, and the like. In the example shown in FIG. 3, the biometrics DB is provided in the authenticating apparatus A 12. However, it is also possible to provide it in the managing apparatus 11 and make biometrics authentication in the managing apparatus 11 through the network.

A result display unit 122 notifies the user of a result of the biometrics authentication, the card issuance discrimination result, and the like by the result display apparatus 12-4.

An authentication data transmitting unit 123 transmits the authentication data to the managing apparatus 11. The authentication data is constructed by “ID” obtained from the biometrics DB 128, the apparatus ID of the authenticating apparatus A 12, and the like (refer to FIG. 6).

A card issuance discrimination result receiving unit 124 receives the card issuance discrimination result transmitted from the managing apparatus 11.

A card issuing unit 125 writes the card input data and issues the card from the card issuing apparatus 12-2.

A control unit 126 controls the control apparatus 12-3. For example, if the control apparatus 12-3 is an electric lock, the electric lock is unlocked. Although the control apparatus 12-3 is controlled here, in a construction without the control apparatus 12-3, after the issuance of the card is executed, the control apparatus is not controlled.

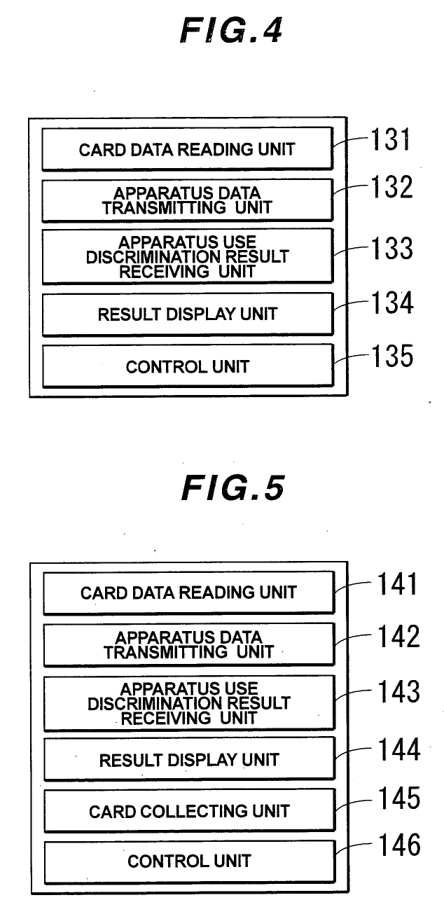

FIG. 4 is the functional block diagram of the authenticating apparatus B 13. In FIG. 4, a card data reading unit 131 reads the card input data by using the card reader 13-1 in FIG. 1.

An apparatus data transmitting unit 132 transmits the apparatus data to the managing apparatus 11. The apparatus data is constructed by the card input data and the apparatus ID (FIG. 9).

An apparatus use discrimination result receiving unit 133 receives an apparatus use discrimination result from the managing apparatus 11 in FIG. 1.

A result display unit 134 displays the apparatus use discrimination result to the result display apparatus 13-3 in FIG. 1.

A control unit 135 controls the control apparatus 13-2 when the apparatus use discrimination indicates OK. For example, if the control apparatus 13-2 is an electric lock, the electric lock is unlocked.

FIG. 5 is the functional block diagram of the authenticating apparatus C 14. In FIG. 5, a card data reading unit 141 reads the card input data by using the card collecting apparatus 14-1 having a card function.

An apparatus data transmitting unit 142 transmits the apparatus data to the managing apparatus 11.

An apparatus use discrimination result receiving unit 143 receives the apparatus use discrimination result from the managing apparatus 11.

A result display unit 144 displays the apparatus use discrimination result to the result display apparatus 14-3.

A card collecting unit 145 collects the card by using the card collecting apparatus 14-1.

A control unit 146 controls the control apparatus 14-2 if the apparatus use discrimination indicates “OK”. For example, if the control apparatus 14-2 is an electric lock, the electric lock is unlocked. Although the control apparatus is controlled by the data of the card here, it is also possible to use a construction in which only the card collection is executed and the control of the control apparatus is not performed. When the control apparatus is controlled, there is also a method of controlling the control apparatus by using the card collection as a trigger without controlling the control apparatus by the data of the card.

<Operation of Embodiment 1>

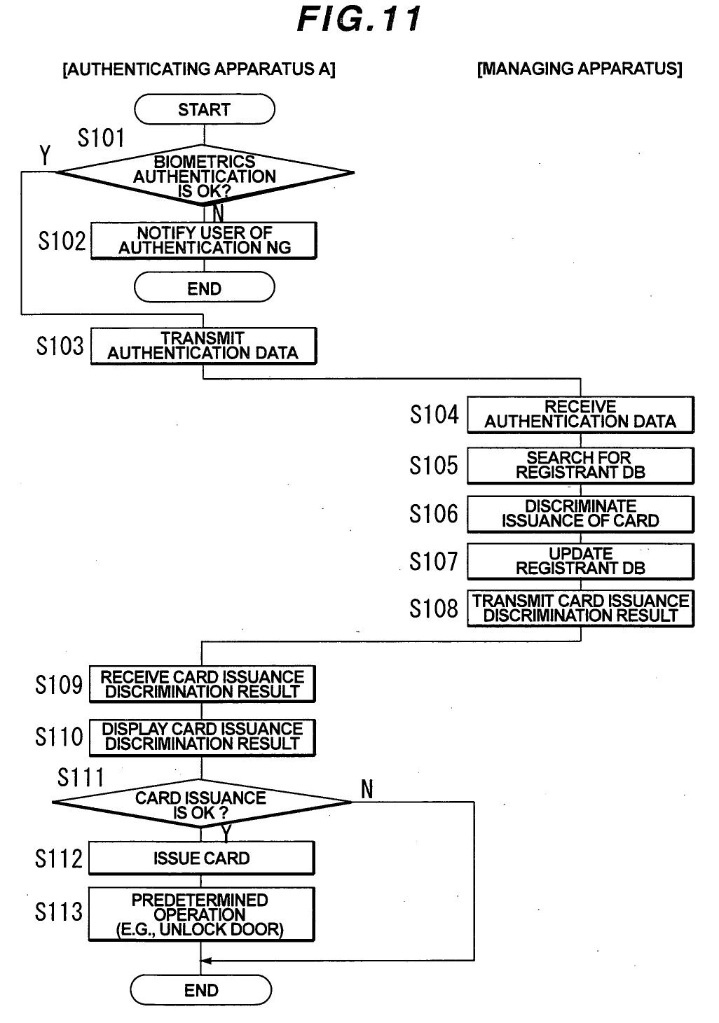

The operation of the embodiment will now be described in accordance with flowcharts of the operation in the embodiment 1 in FIGS. 11, 12, and 13.

FIG. 11 shows the authenticating operation in the authenticating apparatus A 12.

First, in S101, the biometrics authenticating unit 121 executes the biometrics authentication. If the authentication can be made, the processing routine advances to a process of S103. If the authentication cannot be made, the processing routine advances to a process of S102.

In S102, the result display unit 122 notifies the user that the authentication could not be made.

In S103, the authentication data transmitting unit 123 transmits the authentication data to the managing apparatus 11. The operation of the managing apparatus is started here.

First, in S104, the authentication data receiving unit 101 receives the authentication data.

In S105, the registrant DB searching unit 102 searches for the data on the registrant DB 109 on the basis of the ID of the received authentication data.

In S106, the card issuance discriminating unit 103 discriminates whether or not the card is issued on the basis of the searched data.

In S107, the registrant DB updating unit 105 updates the data of the registrant DB 109.

In S108, the card issuance discrimination result transmitting unit 104 transmits the result to the authenticating apparatus A 12. If the card issuance is possible, the result showing that the card can be issued and the card input data are transmitted. If the card issuance is impossible, the result showing that the card cannot be issued is transmitted.

The operation of the authenticating apparatus A is restarted here.

In S109, the card issuance discrimination result receiving unit 124 receives the card issuance discrimination result.

In S110, the result display unit 122 notifies the user of the card issuance discrimination result.

In S111, if the issuing unit 125 can issue the card, the processing routine advances to a process of S112. If the card issuance is impossible, the processing routine is finished.

In S112, the card issuing unit 125 issues the card in which the card input data has been written.

In S113, the control unit 126 executes a predetermined operation. For example, if the authenticating apparatus A is equipped with the electric lock, the unlocking of the electric lock is performed.

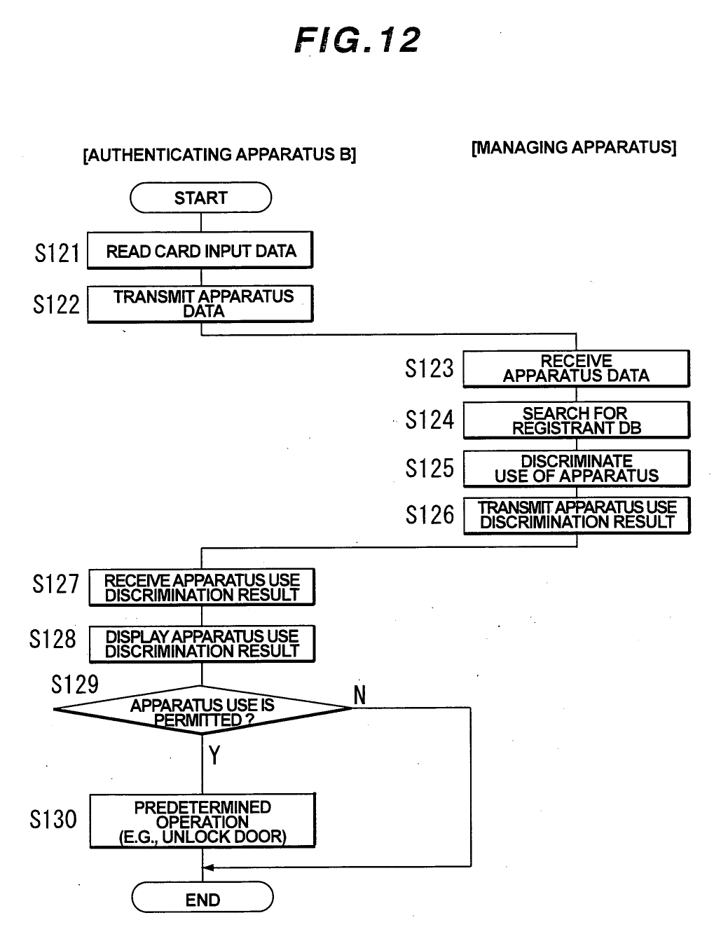

FIG. 12 shows the authenticating operation in the authenticating apparatus B 13.

First, in S121, the card data reading unit 131 reads the card input data of the card issued by the authenticating apparatus A 12.

In S122, the apparatus data transmitting unit 132 transmits the apparatus data to the managing apparatus 11.

The operation of the managing apparatus is started here.

In S123, the apparatus data receiving unit 106 receives the apparatus data.

In S124, the registrant DB searching unit 102 searches for the data on the registrant DB 109 on the basis of the ID of the received apparatus data.

In S125, the apparatus use discriminating unit 107 discriminates whether or not use of the authenticating apparatus B 13 is permitted on the basis of the searched data.

In S126, the apparatus use discrimination result transmitting unit 108 transmits the result to the authenticating apparatus B 13.

The operation of the authenticating apparatus B is restarted here.

In S127, the apparatus use discrimination result receiving unit 133 receives the result.

In S128, the result display unit 134 notifies the user of the apparatus use discrimination result.

In S129, the control unit 135 advances the processing routine to S130 if the apparatus can be used. If the apparatus cannot be used, the processing routine is finished.

In S130, the control unit 135 executes a predetermined operation. For example, if the authenticating apparatus B 13 is equipped with the electric lock, the unlocking of the electric lock is performed.

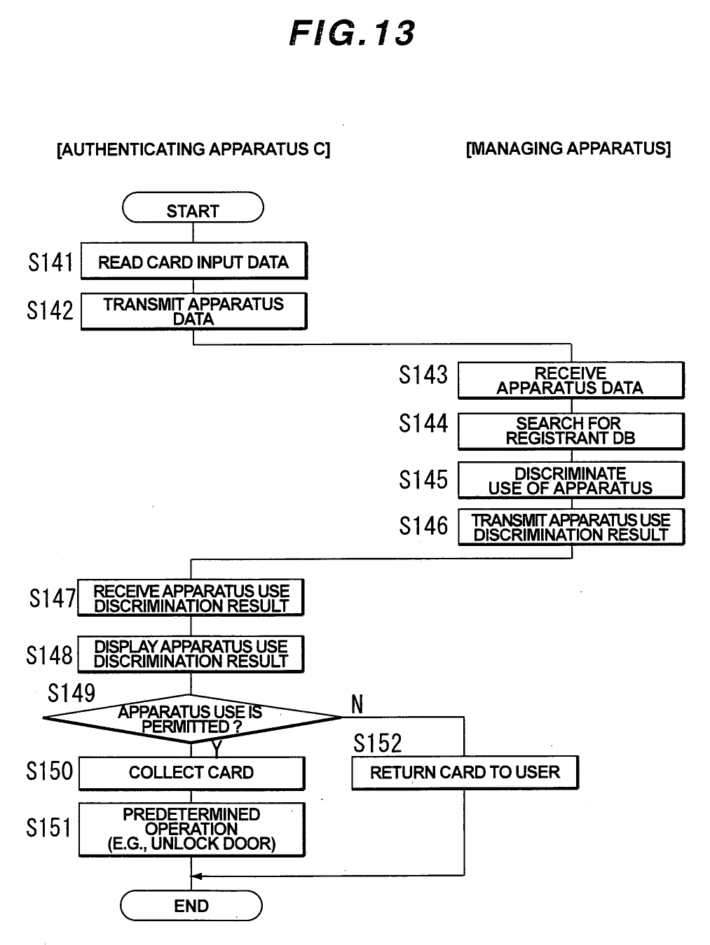

FIG. 13 shows the authenticating operation in the authenticating apparatus C 14.

First, in S141, the card data reading unit 141 reads the card input data of the card issued by the authenticating apparatus A 12.

In S142, the apparatus data transmitting unit 142 transmits the apparatus data to the managing apparatus 11.

The operation of the managing apparatus is started here.

In S143, the apparatus data receiving unit 106 receives the apparatus data.

In S144, the registrant DB searching unit 102 searches for the data on the registrant DB 109 on the basis of the ID of the received apparatus data.

In S145, the apparatus use discriminating unit 107 discriminates whether or not the use of the authenticating apparatus C 14 is permitted on the basis of the searched data.

In S146, the apparatus use discrimination result transmitting unit 108 transmits the result to the authenticating apparatus C 14.

The operation of the authenticating apparatus C is restarted here.

In S147, the apparatus use discrimination result receiving unit 143 receives the result.

In S148, the result display unit 144 notifies the user of the apparatus use discrimination result.

In S149, the card collecting unit 145 advances the processing routine to S150 if the apparatus can be used. If the apparatus cannot be used, the processing routine advances to S152.

In S152, the card collecting unit 145 returns the card to the user. Thus, the processing routine is finished.

In S150, the card collecting unit 145 collects the card.

In S151, the control unit 135 executes a predetermined operation. For example, if the authenticating apparatus C 14 is equipped with the electric lock, the unlocking of the electric lock is performed.

Although the above embodiment has been described with respect to the system in which the authentication by the personal property such as a card or the like and the biometrics authentication are combined. However, the invention is not limited to such a system but can be also similarly realized by a system in which the authentication by an encryption, that is, a password and biometrics authentication are combined. This is also true of embodiments, which will be explained hereinbelow.

<Effects of Embodiment 1>

As described in detail above, convenience of both of the biometrics authentication and the authentication by the personal property can be obtained by the system of the embodiment 1. That is, according to the system, the safety and convenience that there is no need to always carry the card owing to the biometrics authentication can be obtained and convenience that the authentication can be immediately performed owing to the authentication by the personal property can be obtained.

For example, the administration in facilities such as a company or the like will now be considered. At a gate of the company, the biometrics authentication is made by the authenticating apparatus A 12 and the card is obtained. Since the biometrics authentication is made here, high safety can be assured. In this instance, since the card is issued at this place, there is no need to carry the card. In the company, the card and the authenticating apparatus B 13 are used. Payment in a dining room and the management of entering/leaving of the room are executed by the card. In the biometrics, since there is a case where it takes time for collation, there is a possibility that the dining room or the like is crowded. However, since the authentication can be immediately made by the card, the room is not crowded. The card is collected by the authenticating apparatus C 14 when the user leaves the company at last. Therefore, since the card is not taken out of the company, a risk such as theft or the like is low.

In the case where the system is applied to a management system of an apartment, at an entrance of the apartment, an inhabitant registered in the system is subjected to the biometrics authentication by the authenticating apparatus A 12 and obtains a card or a key. The high security can be assured by the execution of the biometrics authentication. In this instance, since the card or key is issued in this place, there is no need to carry them and go out. When he enters his own house, the card or key and the authenticating apparatus B 13 are used. When he goes out, the card and key are collected by the authenticating apparatus C 14 provided at an exit of the apartment. Therefore, they are not taken out of the apartment, a risk such as theft or the like is low.

Embodiment 2

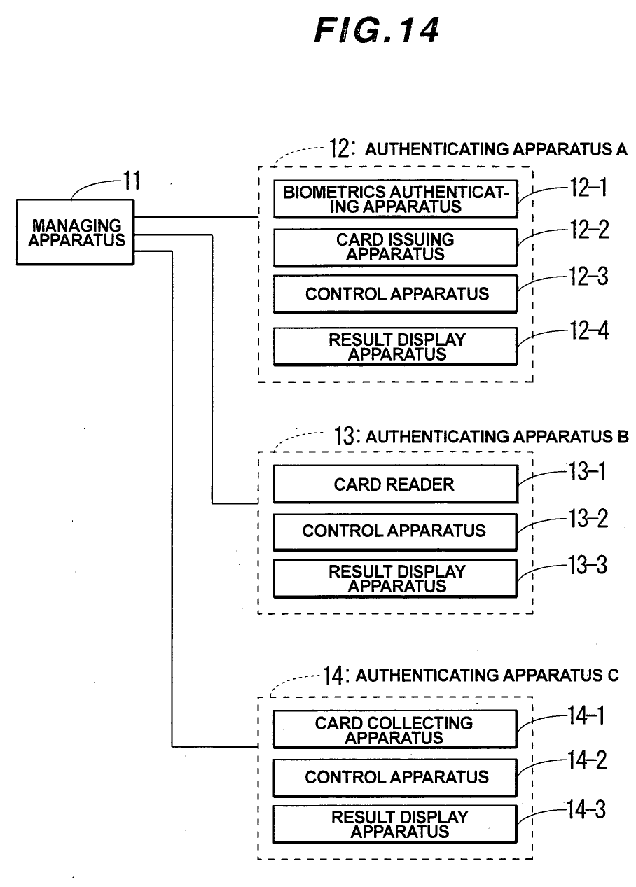

FIG. 14 is a system constructional diagram of the embodiment 2. It differs from the embodiment 1 with respect to a point that although the managing apparatus 11 and the authenticating apparatus A 12 are connected by the network, the authenticating apparatus B 13 and the authenticating apparatus C 14 are not connected to the managing apparatus 11. Other construction is similar to that of the embodiment 1.

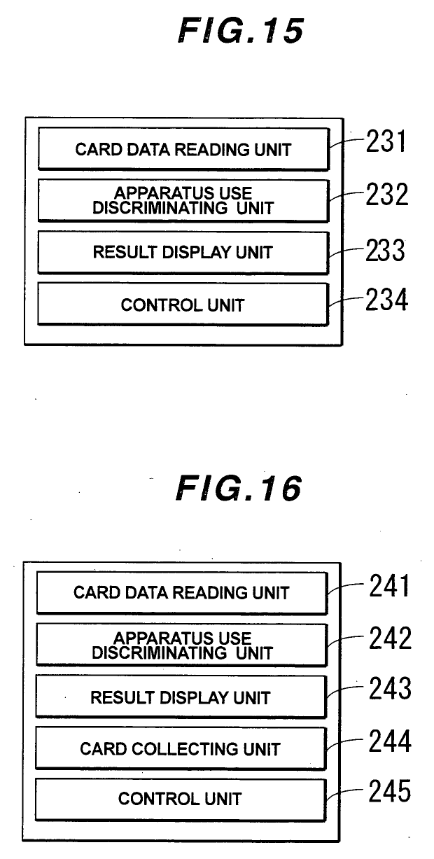

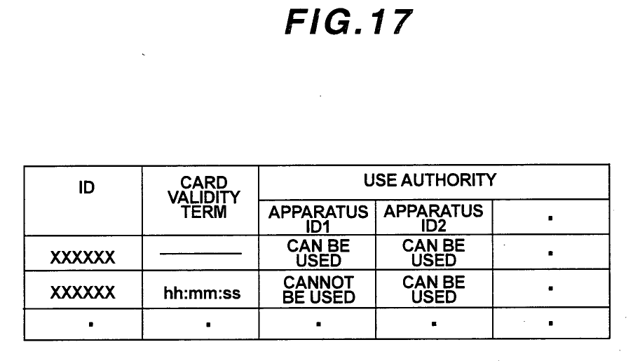

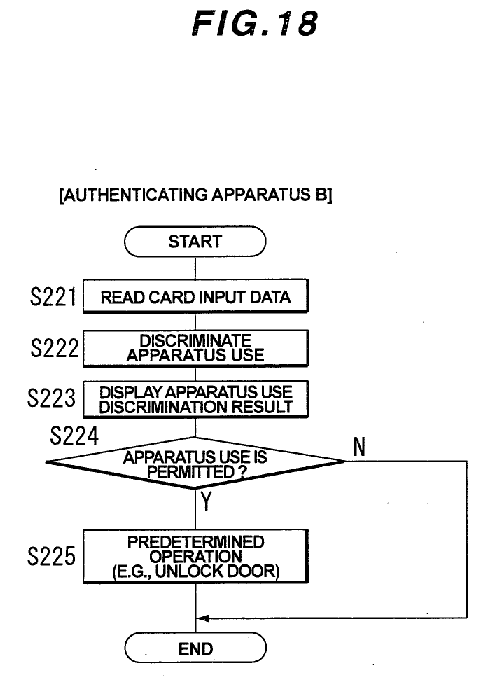

FIGS. 15 and 16 are functional block diagrams of the apparatuses. Functional block diagrams of the managing apparatus and the authenticating apparatus A are similar to those in the embodiment 1. FIG. 17 shows an example of the card input data in the embodiment 2. The card input data is constructed by information such as “ID” as a unique number, “card validity term” showing the terms of validity in which the card can be used, “use authority” showing the apparatus having the use authority, and the like.

FIG. 15 is the functional block diagram of the authenticating apparatus B 13. In FIG. 15, a card data reading unit 231 reads the card input data by using the card reader 13-1. An apparatus use discriminating unit 232 discriminates whether or not use of the apparatus is permitted on the basis of the “card validity term”, “use authority”, and the like. As an example of an apparatus use discrimination, a method -whereby the use is permitted in the case where it is within the card validity term and the use authority of the “apparatus ID” allocated to each apparatus indicates “can be used” can be mentioned.

A result display unit 233 displays a result in the apparatus use discriminating unit 232 to the result display apparatus 13-3. A control unit 234 controls the control apparatus 13-2 when the apparatus use discrimination indicates OK. For example, if the control apparatus 13-2 is an electric lock, the electric lock is unlocked.

FIG. 16 is the functional block diagram of the authenticating apparatus C 14. In FIG. 16, a card data reading unit 241 reads the card input data by using the card collecting apparatus 14-1 having the card function. An apparatus use discriminating unit 242 discriminates whether or not use of the apparatus is permitted on the basis of the “card validity term”, “use authority”, and the like.

A result display unit 243 displays an apparatus use discrimination result to the result display apparatus 14-3. A card collecting unit 244 collects the card by using the card collecting apparatus 14-1. A control unit 245 controls the control apparatus 14-2 when the apparatus use discrimination indicates OK. For example, if the control apparatus 14-2 is an electric lock, the electric lock is unlocked.

<Operation of Embodiment 2>

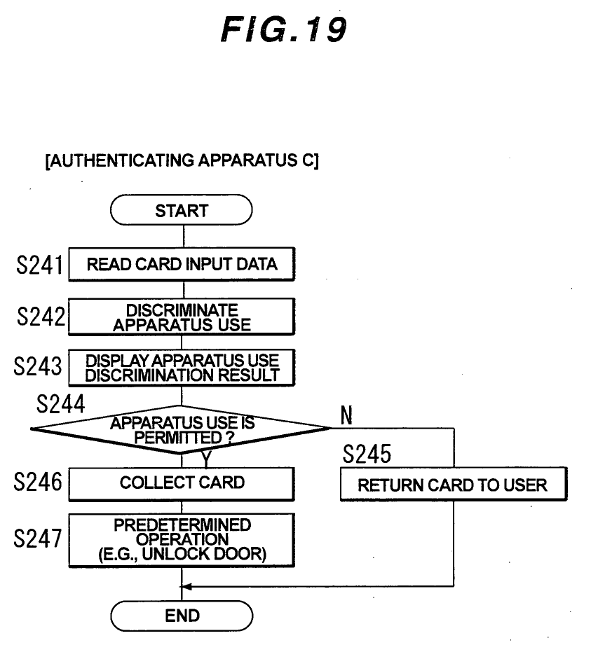

The operation of the embodiment will now be described in accordance with flowcharts of the operation in the embodiment 2 in FIGS. 18 and 19.

The operations of S101 to S113 in FIG. 11 in the embodiment 1 are also similarly executed in the embodiment 2. However, the card input data has contents of FIG. 17.

FIG. 18 shows the authenticating operation in the authenticating apparatus B 13.

First, in S221, the card data reading unit 231 reads the card input data of the card issued by the authenticating apparatus A 12.

In S222, the apparatus use discriminating unit 232 discriminates whether or not the use of the authenticating apparatus B 13 is permitted on the basis of the card input data.

In S223, the result display unit 233 notifies the user of the result of the apparatus use discrimination.

In S224, the control unit 234 advances the processing routine to S225 if the apparatus can be used. If the apparatus cannot be used, the processing routine is finished.

In S225, the control unit 234 executes a predetermined operation. For example, if the authenticating apparatus B 13 is equipped with the electric lock, the unlocking of the electric lock is performed.

FIG. 19 shows the authenticating operation in the authenticating apparatus C 14.

First, in S241, the card data reading unit 241 reads the card input data of the card issued by the authenticating apparatus A 12.

In S242, the apparatus use discriminating unit 242 discriminates whether or not the use of the authenticating apparatus C 14 is permitted on the basis of the card input data.

In S243, the result display unit 243 notifies the user of the apparatus use discrimination result.

In S244, the card collecting unit 244 advances a processing routine to S246 if the apparatus can be used. If the apparatus cannot be used, the processing routine advances to S245.

In S245, the card collecting unit 244 returns the card to the user. In this way, the processing routine is finished.

In S246, the card collecting unit 244 collects the card.

In S247, the control unit 245 executes a predetermined operation. For example, if the authenticating apparatus C 14 is equipped with the electric lock, the unlocking of the electric lock is performed.

<Effects of the Embodiment 2>

As described above in detail, according to the embodiment 2, different from the embodiment 1, the following effects are obtained. That is, although it is necessary that the authenticating apparatuses B 13 and C 14 are connected to the network in the embodiment 1, they are not connected to the network in the embodiment 2. Therefore, even in an environment where those apparatuses cannot be connected to the network, effects similar to those in the embodiment 1 can be obtained.

For example, the administration of a condominium will now be considered. It is assumed that a place where the condominium exists is a place where a network environment is not prepared. The user obtains a card by using the authenticating apparatus A 12. The authenticating apparatus A 12 is arranged at a place where it can be connected to the network. By using the card in the condominium where the authenticating apparatus B 13 has been arranged, the lock of the condominium can be unlocked and the facilities can be used.

Embodiment 3

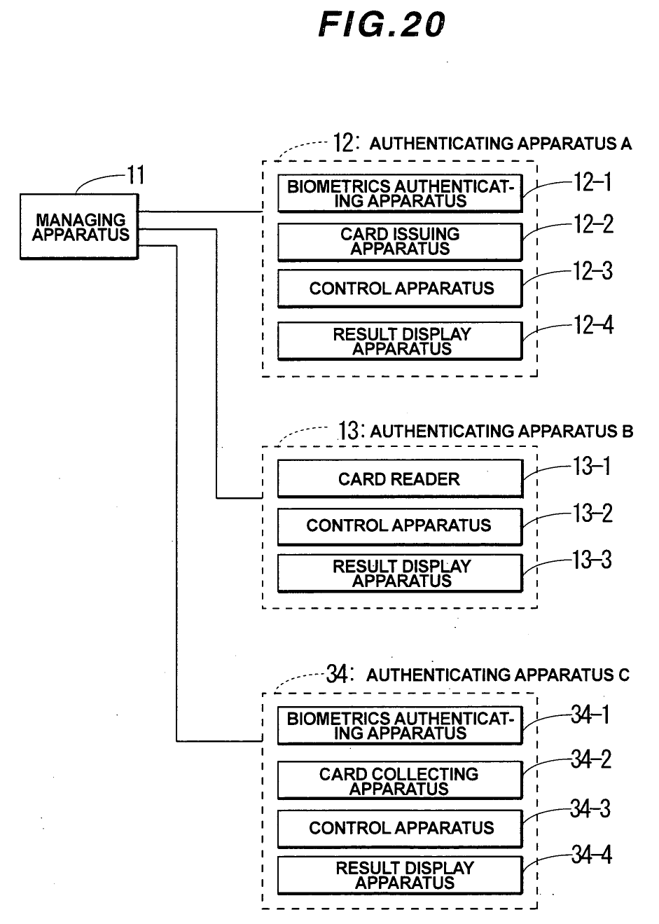

FIG. 20 is a system constructional diagram of an embodiment 3. The embodiment 3 differs from the embodiment 1 with respect to a point that the authenticating apparatus C 14 is equipped with a biometrics authenticating apparatus. The managing apparatus 11 and the authenticating apparatuses A 12 and B 13 are similar to those in the embodiment 1.

An authenticating apparatus C 34 has a biometrics authenticating apparatus 34-1, a card collecting apparatus 34-2, a control apparatus 34-3, and a result display apparatus 34-4. Although the authenticating apparatus C 34 has been provided for the construction of the embodiment 1 here, the authenticating apparatus C 34 can be also provided for the construction of the embodiment 2.

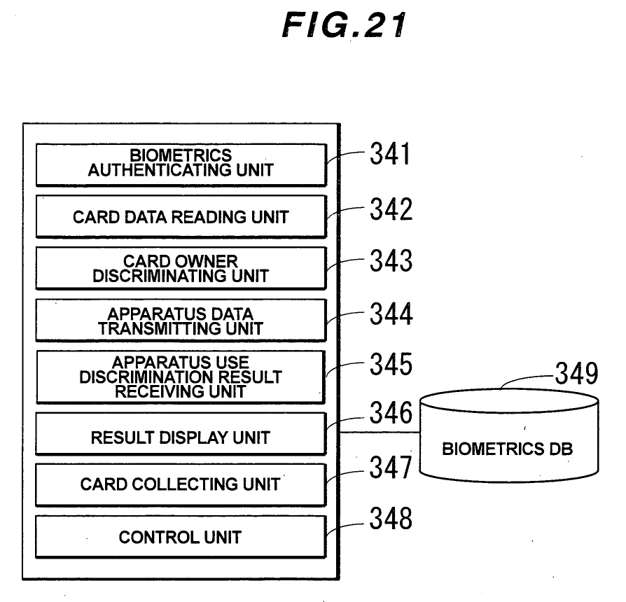

FIG. 21 is a functional block diagram of the apparatuses. The managing apparatus 11 and the authenticating apparatuses A 12 and B 13 are similar to those of the functional block diagram of the embodiment 1.

In FIG. 21, therefore, only the functional block of the authenticating apparatus C 34 is shown. In FIG. 21, a biometrics authenticating unit 341 obtains biometrics data of the user by using the biometrics authenticating apparatus 34-1 and authenticates the user by discriminating whether or not the obtained biometrics data coincides with biometrics data which has previously been registered in a biometrics DB 349.

A card data reading unit 342 reads the card input data by using the card collecting apparatus 34-2 having the card reader function. A card owner discriminating unit 343 discriminates whether or not the ID in the card coincides with the ID obtained by the biometrics authentication. An apparatus data transmitting unit 344 transmits the apparatus data to the managing apparatus 11. An apparatus use discrimination result receiving unit 345 receives an apparatus use discrimination result from the managing apparatus 11.

A result display unit 346 displays an apparatus use discrimination result to the result display apparatus 34-4. A card collecting unit 347 collects the card by using the card collecting apparatus 34-2. A control unit 348 controls the control apparatus 34-3 when the apparatus use discrimination indicates OK. For example, if the control apparatus 34-3 is an electric lock, the electric lock is unlocked. Although the control apparatus is controlled by the data of the card here, it is possible to use a method of controlling the control apparatus by using the card collection as a trigger or a construction in which only the card collection is executed and the control of the control apparatus is not executed.

<Operation of Embodiment 3>

The operations of S101 to S113 in FIG. 11 and S121 to S130 in FIG. 12 in the embodiment 1 are also the same as those in the embodiment 3.

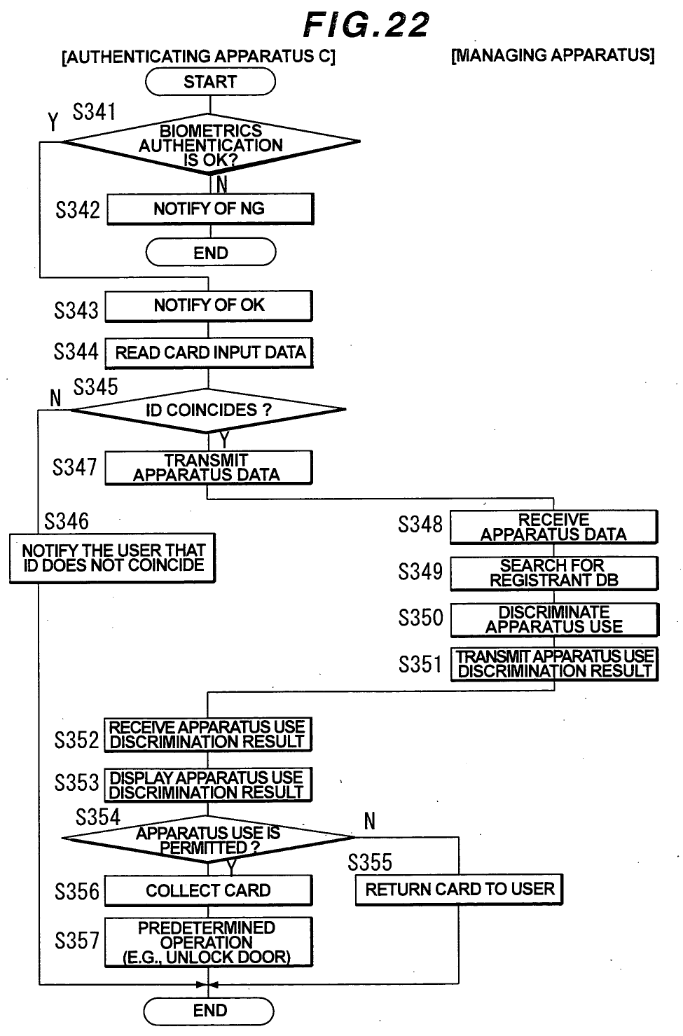

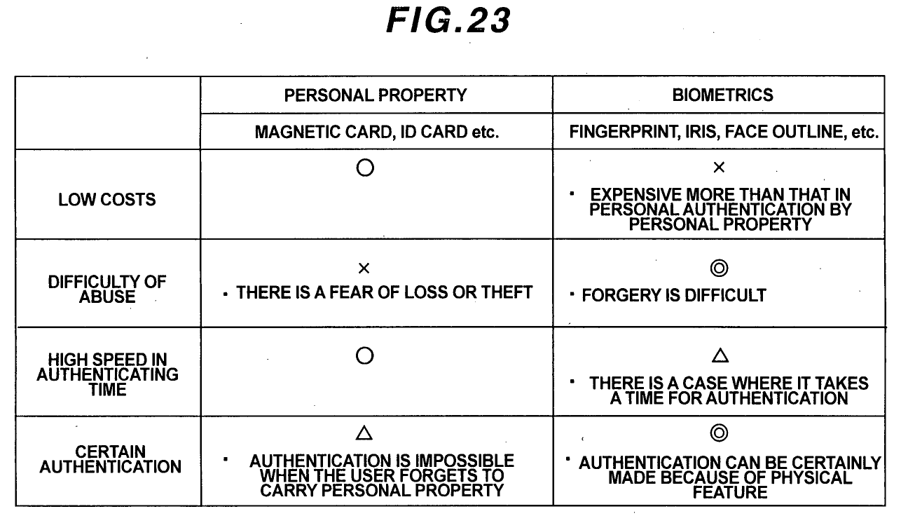

FIG. 22 shows the authenticating operation in the authenticating apparatus C 34.

First, in S341, the biometrics authenticating unit 341 executes the biometrics authentication. If the authentication can be made, the processing routine advances to a process of S343. If the authentication cannot be made, the processing routine advances to a process of S342.

In S342, the result display unit 346 notifies the user of the authentication result NG. The processing routine is finished here.

In S343, the result display unit 346 notifies the user of the authentication result OK.

In S344, the card data reading unit 342 reads the card input data of the card issued by the authenticating apparatus A 12.

In S345, the card owner discriminating unit 343 discriminates whether or not the ID obtained by the biometrics authentication coincides with the ID of the card input data. If they coincide, the processing routine advances to a process of S347. If they do not coincide, the processing routine advances to a process of S346.

In S346, the result display unit 346 notifies the user that the IDs do not coincide.

In S347, the apparatus data transmitting unit 344 transmits the apparatus data to the managing apparatus 11. Thus, the processes in the managing apparatus are started.

In S348, the apparatus data receiving unit 106 receives apparatus data.

In S349, the registrant DB searching unit 102 searches for the data on the registrant DB 109 on the basis of the ID of the authentication data.

In S350, the apparatus use discriminating unit 107 discriminates whether or not the use of the authenticating apparatus C 34 is permitted on the basis of the searched data.

In S351, the apparatus use discrimination result transmitting unit 108 transmits the result to the authenticating apparatus C 34. Thus, the operation of the authenticating apparatus C is restarted.

In S352, the apparatus use discrimination result receiving unit 345 receives the result.

In S353, the result display unit 346 notifies the user of the apparatus use discrimination result.

In S354, the card collecting unit 347 advances the processing routine to S356 if the apparatus can be used. If the apparatus cannot be used, the processing routine advances to S355.

In S355, the card collecting unit 347 returns the card to the user. The processing routine is finished here.

In S356, the card collecting unit 347 collects the card.

In S357, the control unit 348 executes a predetermined operation. For example, if the authenticating apparatus A is equipped with the electric lock, the unlocking of the electric lock is performed.

<Effects of the Embodiment 3>

According to the embodiment 3, it is possible to prevent that the third party gets the card obtained by a certain person by executing the biometrics authentication and illegally uses it.

For example, a lift ticket in a ski resort will be considered. In the ski resort, a problem of a resale of the lift ticket exists. There is a problem that a certain person resells the purchased lift ticket to the third party, so that two or more persons use the same lift ticket. By using the authenticating apparatus C 34, whether or not the lift ticket is a ticket of the purchaser can be discriminated, so that the illegal use such as a resale problem can be prevented.

Specifically speaking, when the lift ticket is purchased, a deposit is kept from the purchaser by the authenticating apparatus A and the deposit is returned to the purchaser confirmed by the biometrics authentication by the authenticating apparatus C under the condition that the lift ticket is returned.

1. A multi-authenticating method also for use in organism authentication, comprising the steps of:
making the organism authentication by using a physical feature of an authentication target and, when a result of said organism authentication indicates an affirmative, thereafter issuing an authenticating medium by which simple and prompt authentication can be made on the assumption that the affirmative result of the organism authentication is obtained; and
authenticating the authentication target by using said authenticating medium and permitting use of an apparatus in accordance with a result of the authentication by said authenticating medium.

2. The multi-authenticating method also for use in the organism authentication according to claim 1, wherein said authenticating medium is a personal property of the user of the apparatus as an authentication target.

3. The multi-authenticating method also for use in the organism authentication according to claim 1, wherein said authenticating medium is a password.

4. The multi-authenticating method also for use in the organism authentication according to claim 2, further comprising the step of collecting the personal property as said authenticating medium.

5. A multi-authenticating system also for use in organism authentication, comprising:
a first authenticating apparatus constructed by an organism authenticating unit which makes the organism authentication by using a physical feature of an authentication target and a medium issuing unit which issues an authenticating medium when a result of said organism authentication indicates an affirmative; and
a second authenticating apparatus constructed by a medium authenticating unit which authenticates the authentication target by using said authenticating medium and an apparatus control unit which permits use of an apparatus in accordance with a result of the authentication by said authenticating medium.

6. The multi-authenticating system also for use in organism authentication according to claim 5, wherein said authenticating medium is a personal property of the user of the apparatus as an authentication target.

7. The multi-authenticating system also for use in the organism authentication according to claim 5, wherein said authenticating medium is a password.

8. The multi-authenticating system also for use in the organism authentication according to claim 6, further comprising a collecting unit which collects the personal property as said authenticating medium.

9. The multi-authenticating system also for use in the organism authentication according to claim 6, wherein
said first authenticating apparatus writes all data necessary for the subsequent authentication into the personal property of the user of the apparatus, and
said second authenticating apparatus can solely discriminate whether or not the use of the apparatus is permitted on the basis of the data obtained from said personal property.

10. The multi-authenticating method also for use in the organism authentication according to claim 4, wherein the organism authentication is accompanied in the step of collecting the personal property as said authenticating medium.

11. The multi-authenticating system also for use in the organism authentication according to claim 8, wherein the organism authenticating unit which makes the organism authentication at the time of the collection of said personal property is provided in a recognizing apparatus having the collecting unit which collects the personal property as said authenticating medium.
